(19) United States
(12) Patent Application Publication
(10) Pub. No.: US 2017/0213161 A1
(43) Pub. Date: Jul. 27, 2017

(54) SYSTEM, METHOD, AND APPARATUS FOR PROVIDING AND MANAGING INTRA-DAY RESERVATIONS

(71) Applicant: HotelsByDay, LLC, New York, NY (US)

(72) Inventors: Yannis MOATI, New York, NY (US); Brian DASS, New York, NY (US); Nathan STEVENSON, New York, NY (US)

(21) Appl. No.: 15/326,956

(22) PCT Filed: Jul. 17, 2015
(86) PCT No.: PCT/US15/40969

§ 371 Date: Jan. 17, 2017

Related U.S. Application Data
(60) Provisional application No. 62/025,825, filed on Jul. 17, 2014.

(51) Int. Cl. G06Q 10/02; G06Q 50/12

(52) U.S. Cl. CPC G06Q 10/02; G06Q 50/12

(57) ABSTRACT

An approach is provided for facilitating reservations of resources for a shorter time period (e.g., intra-day booking) than a traditional daily reservation and/or for extending reservations beyond the limits of traditional reservation times (e.g., check-in, check-out, etc.) The approach includes specifying an intra-day booking period for a resource, wherein the intra-day booking period is a period less than a daily booking period for the resource. The approach also includes interfacing with a channel manager platform to provide for an intra-day reservation of the resource based on the intra-day booking period, wherein the channel manager platform is configured to manage the resource. The approach further includes initiating the intra-day reservation of the resource based on a user intra-day reservation request.

### RELATED APPLICATION

This application claims priority to U.S. Provisional Application No. 62/025,825, filed Jul. 17, 2014, titled “System, Method, and Apparatus for Providing Intra-Day Reservations,” the contents of which are herein incorporated by reference in their entirety.

### BACKGROUND

An important aspect of hotel management is the optimal utilization of resources (e.g., hotel rooms) that are available for reservation by its customers. In many cases, businesses such as hotels typically employ automated systems (e.g., room reservation systems) that manage and track bookings or reservations of their resources (e.g., rooms) to gather real time knowledge of occupancy or utilization rates. Traditionally, such room reservation systems generally have provided for resource reservations on a daily basis. One of the reasons for not providing reservations for shorter periods, e.g., on hourly basis, is because managing these reservations is significantly more complex than reservations on daily basis. However, as travel demands become more varied (e.g., greater prevalence of last minute bookings, intra-day bookings, etc.) and as hotels seek to further increase occupancy rates, traditional reservation practices that rely on daily bookings may limit such goals.

### SOME EXAMPLE EMBODIMENTS

Therefore, there is a need for providing booking or reservation schemes to accommodate, for instance, shoulder period extension of booked reservations and last minute intra-day bookings that allow hotels and other establishments to control reservations at finer temporal granularity and potentially increase occupancy rates over shorter occupancy periods.

According to one embodiment, a method comprises specifying an intra-day booking period for a resource, wherein the intra-day booking period is a period less than a daily booking period for the resource. The method also comprises interfacing with a channel manager platform to provide for an intra-day reservation of the resource based on the intra-day booking period, wherein the channel manager platform is configured to manage the resource. The method further comprises initiating the intra-day reservation of the resource based on a user intra-day reservation request.

According to another embodiment, an apparatus comprises at least one processor, and at least one memory including computer program code for one or more computer programs, the at least one memory and the computer program code configured to, with the at least one processor, cause, at least in part, the apparatus to specify an intra-day booking period for a resource, wherein the intra-day booking period is a period less than a daily booking period for the resource. The apparatus is also caused to interface with a channel manager platform to provide for an intra-day reservation of the resource based on the intra-day booking period, wherein the channel manager platform is configured to manage the resource. The apparatus is further caused to initiate the intra-day reservation of the resource based on a user intra-day reservation request.

According to another embodiment, a computer-readable storage medium carries one or more sequences of one or more instructions which, when executed by one or more processors, cause, at least in part, an apparatus to specify an intra-day booking period for a resource, wherein the intra-day booking period is a period less than a daily booking period for the resource. The apparatus is also caused to interface with a channel manager platform to provide for an intra-day reservation of the resource based on the intra-day booking period, wherein the channel manager platform is configured to manage the resource. The apparatus is further caused to initiate the intra-day reservation of the resource based on a user intra-day reservation request.

According to another embodiment, an apparatus comprises means for specifying an intra-day booking period for a resource, wherein the intra-day booking period is a period less than a daily booking period for the resource. The apparatus also comprises means for interfacing with a channel manager platform to provide for an intra-day reservation of the resource based on the intra-day booking period, wherein the channel manager platform is configured to manage the resource. The apparatus further comprises means for initiating the intra-day reservation of the resource based on a user intra-day reservation request.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-8 and 26-28.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system architecture capable of facilitating or making intra-day reservations, according to one embodiment;

FIG. 2A is a diagram of a logic layer of a system for facilitating intra-day reservations, according to one embodiment;

FIG. 2B is a flowchart of a process for facilitating a flexible booking process, according to one embodiment;

FIGS. 3 and 4 are flowcharts of various processes for, at least, facilitating intra-day reservations of resources, according to various embodiments;

FIGS. 5A-5C illustrate diagrams of a user interface for making intra-day reservation, according to various embodiments;

FIG. 6 illustrates an example user interface including options for an intra-day reservation system, according to one embodiment;

FIGS. 7A-7B illustrate diagrams of a dashboard user interface for monitoring intra-day reservation system activities, according to one embodiment;

FIG. 7C is a diagram of a user interface for managing reservations in the intra-day reservation system, according to one embodiment;

FIG. 7D illustrates a list of participating hotels in the intra-day reservation managing system, according to one embodiment;

FIG. 7E illustrates information on intra-day resources by geographic locations such as cities, states, countries, or the like regions, according to one embodiment;

FIG. 8 is a diagram of a computer system for implementing various exemplary embodiments; and

FIG. 9 is a diagram of a chip set for implementing an embodiment of the invention.

### DESCRIPTION OF SOME EMBODIMENTS

A preferred method, apparatus and system for providing and managing intra-day, last minute, and shoulder period reservations are herein described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a hotel-related resource, it is contemplated that these embodiments have applicability to any other type of resource available for reservation from any provider. For example, although the various embodiments discuss hotel rooms as examples of resources available for reservation or booking, it is contemplated that other resources such as conference rooms, equipment, work spaces, and/or any other property can be used with the processes of the various embodiments.

As noted above, traditional reservation and booking systems for hotel rooms are managed in daily blocks (e.g., with fixed check-in and check-out times). However, in some cases, there is a need for reservations that span a shorter time period or for extending reservations to periods immediately before traditional check in times and/or immediately after traditional check out times, thereby enabling a greater number of reservations over an equivalent time period to facilitate an increase in occupancy and/or resource utilization rates.

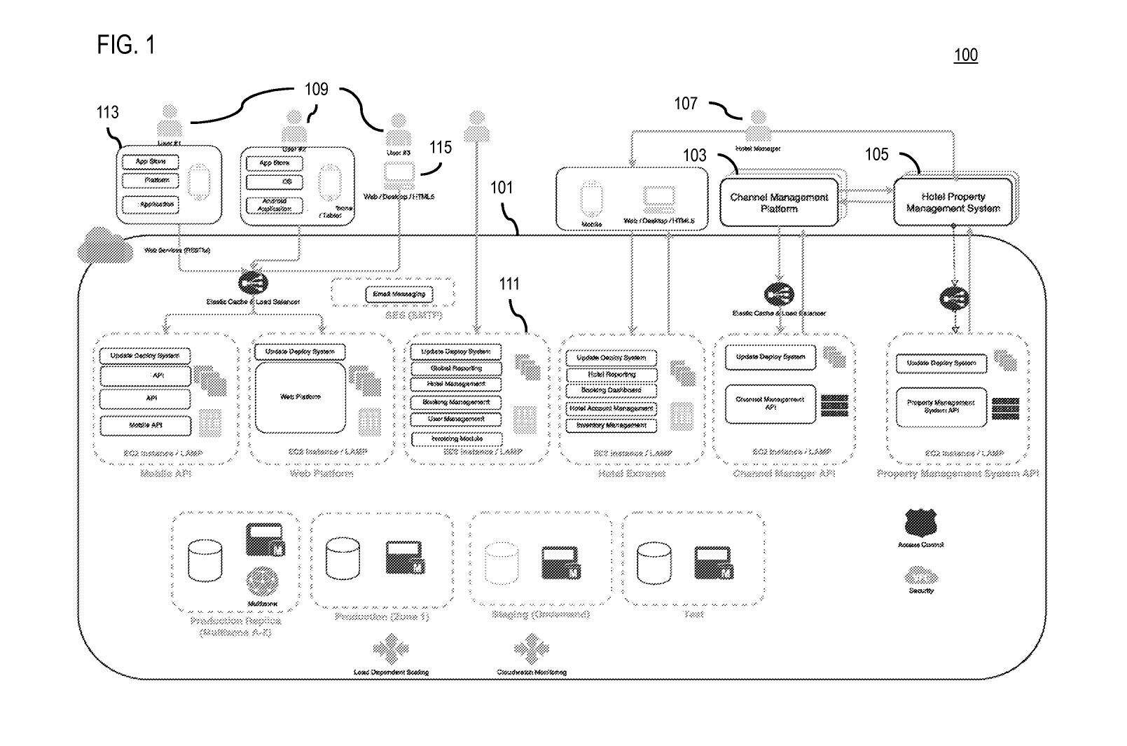

To address this need, system 100 of FIG. 1 introduces the capability to provide a process for facilitating and/or making resource (e.g., a hotel room, a conference center, a vehicle, etc.) reservations that span a shorter time period (e.g., a day time or “intra-day” booking) than the traditional daily booking, and for extending reservations that extend beyond the limits of traditional check in and/or check out times. In one embodiment, for the purposes of standardization, the intra-day period can be specified as discrete units of time. For example, two time periods can be utilized: (1) 7 AM (or 8 AM)-4 PM, and (2) 11 PM-5 AM (or 6 AM) that correspond, for instance, to time periods before and/or after traditional reservation periods. In one embodiment, when used to extend traditional reservations, these “Before” and “After” time periods can be applied to the customary night stay to provide a continuous booking of the room. It is contemplated that other Before and After time periods can be established according to the particular operations of a hotel so as to maintain such continuous booking.

In one embodiment, the mechanism of continuous booking in the system will allow for unsold inventory or a portion thereof as of, e.g., midnight to automatically be tagged as “Intra-day inventory”, then the number of continuous bookings available on the following day would be the lesser of the number of intra-day tagged rooms and overnight inventory remaining. By way of example, at the point of booking a continuous booking, a guest would select check-in time (8 AM or customary 4 PM) and check-out time (customary 12 noon or 6 PM). An algorithm in the system 100 will then draw from the pool of intra-day tagged rooms and from the pool of unsold overnight inventory for the property and match the before, overnight and after periods as selected by the guest to create one continuous booking. The intra-day inventory and overnight inventory pools will then be decremented by 1 of each time period.

In this embodiment, the flex res time periods would have, for instance, two global distribution system (GDS) codes (before & after intraday inventory) to simplify travel manager and travel agent booking process in the creation of customized itineraries.

In one embodiment, the system 100 provides consumers with the ease of booking the rooms or resources themselves, while also providing the providers (e.g., hotels) with the ability to monitor and update their supply of these resources or rooms.

In one embodiment, an intra-day reservation platform 101 may interface with a “channel manager” system (CMS) 103, a central reservation system (CRS), a global distribution system (GDS), property management system (PMS) 105, or the like entities for effectuating an intra-day reservation of a resource. By way of example, these platforms enable hotels or other resource providers to put rates for use of resources into one application and distribute the rates to appropriate online travel agents/agencies (OTAs), or GDS that may include networks operated by companies that enable automated transaction between third-parties and booking agents for airlines, car rentals and hire services, etc. In one embodiment, the platform 101 may include features and capabilities that allow a hotel to set protocols and rules for how the hotel wants to manage the supply of resources on those channels.

More specifically, in one embodiment, the platform 101 may facilitate automation of intra-day bookings to enable any hotel or provider to give consumers the option of booking the hotel room or other resource for shorter time periods (e.g., during the day). In one embodiment, platform 101 may use XML protocol and standard messaging through, for instance, Hotel Technology Next Generation (HTNG); electronic data interchange for administration, commerce and transport (EDIFACT), or similar protocols to facilitate intra-day or shorter time bookings. In one embodiment, the system 100 may provide for modifications to these standard protocols or creation of new protocols supported by the channel managers to support intra-day bookings. In one embodiment, the system 100 provides for a process flow to link property management systems (PMS) 105 (e.g., systems used by hotels to manage their inventory, rates, occupancy, etc.) to channel managers 107 (e.g., via CMS 103), and consumers/users/customers 109, an intra-day booking/reservation system 111, and vice versa. In some embodiments, it is contemplated that other third-party systems, such as systems that allow hotels to offer special items (e.g., dinner reservation, event tickets), car rentals, etc., may be integrated to the above-mentioned systems and/or to the platform herein described. Additionally, the system herein described may be integrated to systems that enable automated transactions between third parties and booking agents, hotels etc. It is also contemplated that all these systems may be directly or indirectly connected to the consumer 109, including the platform 101 herein provided. In one example, a provider may interface with the platform 101 to provide a bundling of various resources in an “opaque” package, where the cost of an intra-day resource (e.g., a room) may be adjusted with a discount.

In one embodiment, the system provides at least two methods for making intra-day or shorter bookings according to the various embodiments described herein. The methods include a native application (e.g., an iOS and/or Android application) in a user device 113, and/or an online portal or client 115 (e.g., website). By way of example, the user may use a mobile device, smart phone, tablet, netbook, laptop, sensor, set-top box, or any communications enabled computing device to access any of the booking methods. It is contemplated that the reservation can be made by the consumers 109 or the provider 107 (e.g., hotel manager, agent, etc.), who may place the reservation into the system after receiving a communication (e.g., a phone call, a text message, an email, etc.) from the consumer 109 requesting reservation.

In one embodiment, via a booking method, a user 109 may select his/her location and requested date, and is presented with a number of options to book a hotel during the day or some other intra-day time period. In one embodiment, the user can make a reservation without a credit card or can guarantee a reservation by adding credit card details. Once the user has selected the hotel, the hotel is notified and a confirmation is sent to the customer. When the customer arrives, the customer can either pay during checking out of the hotel if the customer has not guaranteed the reservation with a credit card or the previously provided credit card is debited during check in. In one scenario, a user may pay at the time of making the reservation (e.g., advance purchase), for example, so to take advantage of special offerings by the provider.

In one embodiment, a customer 109 will have an opportunity to request an extension (e.g., via a one-click overnight extension whereby a notification will be sent to the customer when the end of their reservation is approaching and allow the customer to book the same room for another period or convert to a traditional overnight/daily booking). If the user selects yes then the hotel is notified and the user may remain in the user's room(s) or may be asked/offered to move into another room. In one embodiment, once the consumer is checked out, the user is sent a receipt for the stay and a history is stored in their application or online for later access. In another embodiment, the billing information may be sent to one or more entities associated with and/or authorized by the user. For example, the billing information may be provided to a bank, a credit card company, user's employer, an accountant, or the like.

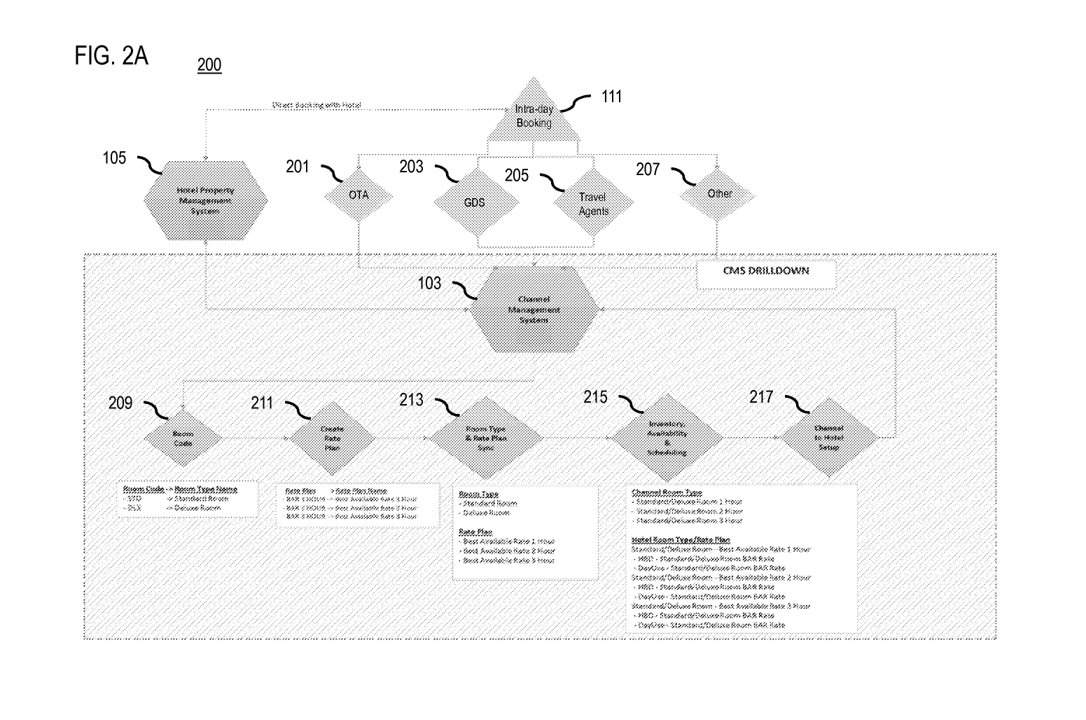

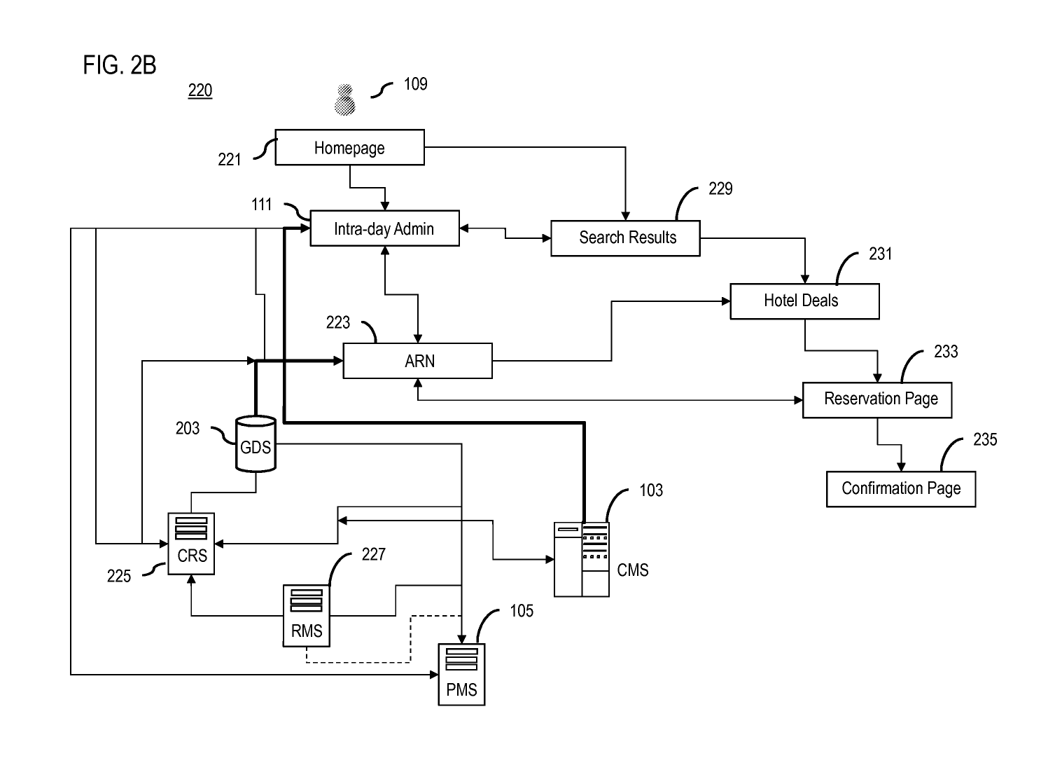

FIG. 2A is a diagram of a logic layer 200 of the system 100 for facilitating intra-day reservations, according to one embodiment. In one embodiment, the system 100 may include a back-end comprising a business logic layer and database(s) which store information about the hotel or provider, rates, inventory, etc. In one embodiment, the back end interfaces directly with the channel managers, the provider administrator (e.g., hotel administrator) interface, and/or the consumer requests received from online and/or client applications. In one embodiment, the business layer contains logic code which enables the intra-day booking functionality for consumers, providers (e.g., hotel managers), system administrators, etc. to manipulate the system. In one embodiment, the intra-day booking system 111 may interface directly with a hotel property management system 105 for effectuating an intra-day reservation of a resource for one or more customers. In some embodiments, the intra-day booking system 111 may interface with one or more intermediary entities such as an OTA 201, a GDS 203, traditional travel agents 205, or other entities 207 associated with the system 100. In one embodiment, a CMS 103 may interface with any of the hotel property management system 105, OTA 201, GDS 203, traditional travel agents 205, other entities 207, or the like. A CMS 103 may manage inventory, availability, and scheduling of resources associated with a resource provider (e.g., a hotel). For example, a CMS 103 may set and manage a date range that is to be applied to a rate plan for available resources (e.g., hotel rooms). Additionally, a CMS 103 may determine appropriate taxes, commissions, or any updates to any of the information associated with the entities of the system 100. In some instances, the CMS 103 may interface with one or more logic processes, which may determine resource/room codes and types 209 (e.g., std, dlx, standard room, deluxe room, etc.) and rate plans 211 (e.g., an hourly room rate) associated with the resources. At 213, the available room types and rate plans may be synchronized, which may be utilized in 215 to determine inventory, availability and scheduling. For example, the logic process, at 215, may determine and create one or more rate plans for one or more available hotel room types. At 217, the information from 215 may be returned to the CMS 103 for communication to the hotel management system 105, which may communicate the information on available intra-day resources to the intra-day booking system 111. In one embodiment, the intra-day booking system 111, the GDS 203, a PMS 105, or a CRS may communicate directly (e.g., by passing CMS 103) for determining and communicating information associated with intra-day reservations.

FIG. 2B is a flowchart of a process 220 for facilitating a flexible booking process, according to one embodiment.

In one embodiment, the process 220 may begin when a user 109 interacts with a an online user interface page 221 to search for information on intra-day resources (e.g., a hotel room). The intra-day administration 111 may determine the information associated with the requested resource from ARN 223, which may directly or indirectly communicate with a CMS 103, a PMS 105, a GDS 203, a CRS 225, a revenue management system (RMS) 227, or other like entities in the system 100. Additionally, the user may be directed to a presentation of search results at 229, where the results may be provided by the intra-day administration 111 based, at least in part, on information from the GDS 203, CMS 103, or ARN 223. In one scenario, the ARN 223 may determine and provide information about available deals/programs associated with one or more resources from one or more providers. For example, at step 231, one or more hotel deals may be presented to the user 109, where the user may review the information. At step 233, the ARN may present additional information or options for the user to review and possibly request for a reservation of a resource. The interface at 233 may allow for further communications between the user 109 and the ARN to further refine options, e.g., check-in/check-out time/date, for a reservation. Upon a request and an agreement for a reservation of a resource, the user may proceed to the confirmation page 235 to confirm a reservation.

In one embodiment, the flexible booking process allows the user/guests to book a reservation beyond the limits of traditional check in and check out times, and that allows the provider to make these flexible reservations available to the users. For example, if the over-night period for a reservation is from 2:00 PM. through 11:00 AM, the user may request for his/her check in time to be before 2:00 PM, for his/her check out time to be after 11:00 AM, or for both. This request may be done at any time, e.g., before check in or during the stay. Accordingly, the user and the provider do not need to rely on the traditional judgment call made by e.g., a hotel manager on a case by case basis on whether or not the provider can allow the user/guest into the room earlier than the check in time and/or later than the checkout time, while the user does not need to manually get in touch (e.g., call the front desk) with the hotel to request different check in or checkout time.

The flexible reservations may be valuable, for example, for hotels that do not wish to make isolated intra-day reservation available, but wish to make shoulder periods available in connection with an over-night-type of reservation. Accordingly, the user and the provider do not need to rely on the traditional 24 hour booking periods but rather offering any combination of hours, e.g., less than 24 hours (intra-day) or 24 hours combined with additional hours (e.g., 36 hours). In one example, a user and a provider may agree to an over-night booking from 2:00 PM and a check-out time of 5:00 PM on the following day (e.g., instead of 11:00 AM). This shoulder type of reservation could be applied as early check-in on overnight bookings (e.g., 7:00 AM to 2:00 PM check-out on the following day) or late check-out on overnight bookings (11:00 AM to 7:00 PM check-out on the following day). Further, it may be applied to extend overnight bookings, e.g., if the user is checking-in for multiple overnight stays.

A flexible reservation may be made available by presenting the user with a search result of providers that make the flexible reservation available. Once the result is presented, the user may select periods before the check in time and after the checkout time associated with his/her overnight from a time band pull down list for available periods, such as only immediately before check in time, only immediately after checkout time, or both. It is contemplated that the amount to be charged relative to the over-night stay and the amount relative to the shoulder time is displayed separately or in combination so the user can decide on whether to proceed with the reservation of the extra time.

In another embodiment, once the user selects a time period, the provider reserves the right to charge the user/guest for an extra night or a fraction of the extra night. For example, if an overnight booking cost $300 for one night and the check in time at the hotel is 2:00 PM but the user/guest needs to arrive early in the morning, the hotel reserves the right to charge the user/guest for the night before, so the one night stay with an early check in could result in as much as $600 or as little as $450 of charges to the user/guest.

In yet another embodiment, should the user be charged a fraction of the extra day, the user may have an option to risk the fraction of the extra day with no guarantee in exchange for the possibility of getting the extra time at no cost.

It is contemplated that to avoid the inconvenience of taking the risk, the ability to have intra-day as an option on these shoulder times (i.e. earlier than check in time and later than check out time) can be guaranteed. It is also contemplated that these flexible reservations can be made available for non-overnight reservation, i.e. the flexible reservations can also be made available in association with the intra-day reservations. In one embodiment, the user may be able to cancel his/her reservation with no penalties attached so long as the reservation is cancelled within an appropriate time frame. It is contemplated that this might also apply to user that may have ended with a higher rate for overnight bookings. It is also contemplated that once the reservation is booked and paid, the amount paid is nonrefundable.

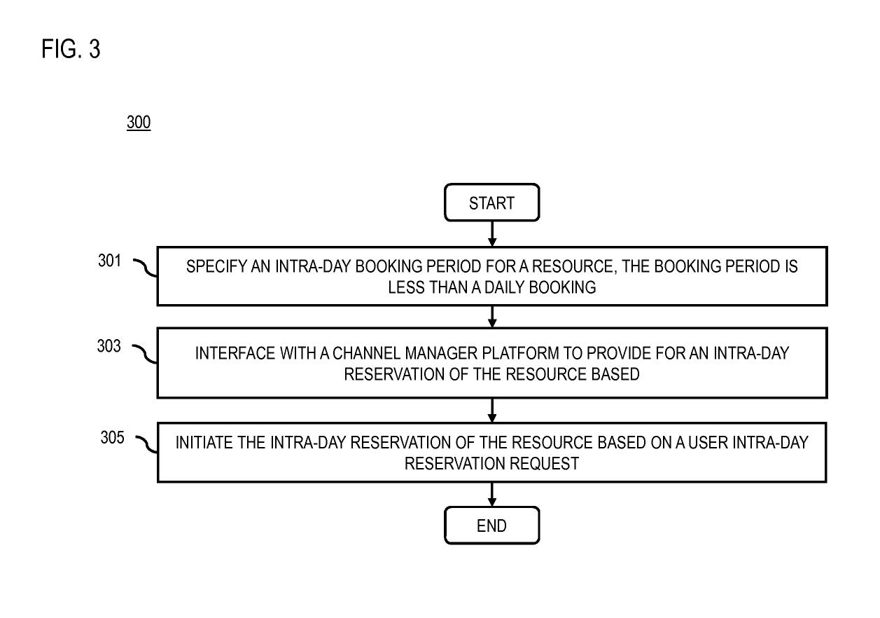

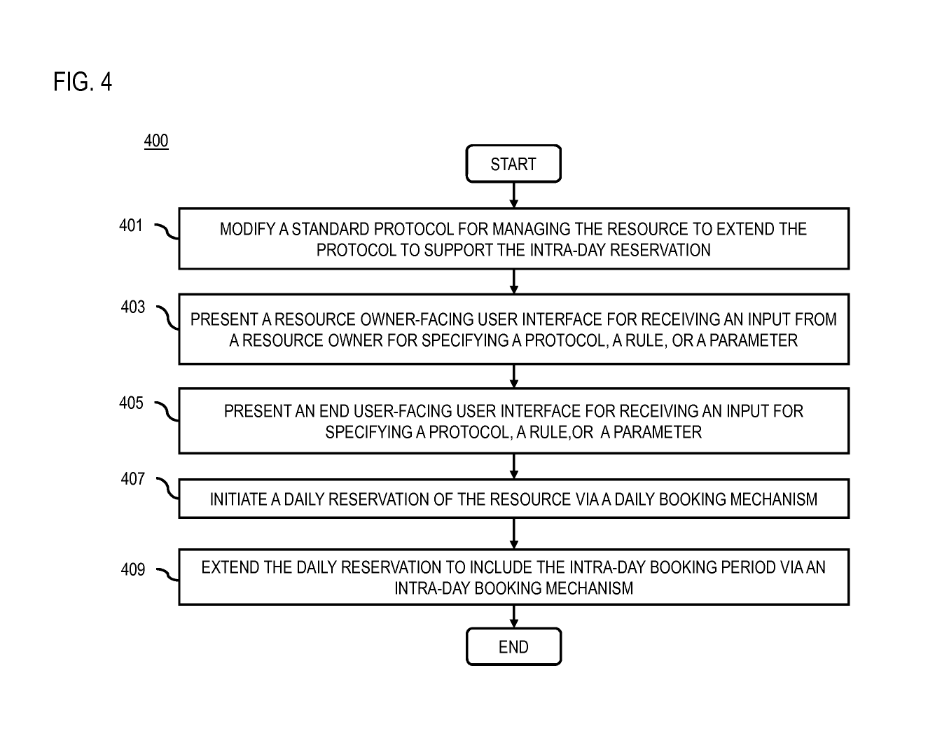

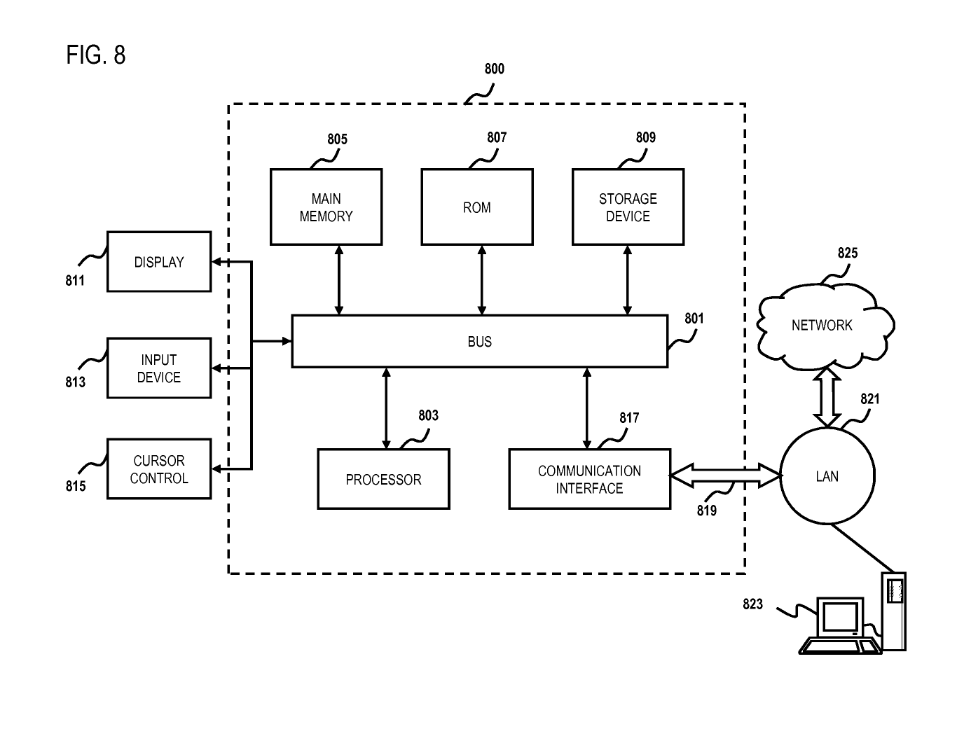

FIGS. 3 and 4 are flowcharts of various processes for, at least, facilitating intra-day reservations of resources. In various embodiments, the intra-day reservation system 111 may perform one or more portions of the processes 300 and 400, which may be implemented in, for instance, a chip set including a processor and a memory as shown in FIG. 8. As such, the intra-day reservation system 111 can provide means for accomplishing various parts of the process 300 and 400 as well as means for accomplishing other processes in conjunction with other components of the system 100. Throughout these processes, the intra-day reservation system 111 may be referred to as completing various portions of the processes 300 and 400, however, it is understood that other components of the system 100 can perform some of and/or all of the process steps. Further, for clarity in discussing the processes 300 and 400, the intra-day reservation system 111 is referred to as completing various steps of said processes; however, said processes and/or example steps described therein may be performed in any suitable order and/or may be optional.

The process 300 may begin at step 301 of the FIG. 3, where the intra-day booking system 111 may specify an intra-day booking period for a resource, wherein the intra-day booking period is a period less than a daily booking period for the resource. In one scenario, an intra-day booking system may determine intra-day booking periods of one or more resources based on information associated with the resources. For example, an intra-day booking system may have access to a list of resource inventory that may be available from various resource providers at a given location, for a range of dates, resource types, or the like.

At step 303, intra-day booking system 111 may interface with a channel manager platform to provide for an intra-day reservation of the resource based on the intra-day booking period, wherein the channel manager platform is configured to manage the resource. In one embodiment, the channel manager platform further interfaces with a resource property management system to manage the resource. In one instance, a channel manager platform may be associated with one or more hotel property management systems for managing an intra-day reservation of a resource for one or more customers. In some embodiments, the intra-day booking system 111 may interface with one or more intermediary entities such as an OTA 201, a GDS 203, traditional travel agents 205, or other entities 207, which may interface with the channel manager platform for an intra-day booking of a resource for one or more users.

At step 305, intra-day booking system 111 may initiate the intra-day reservation of the resource based on a user intra-day reservation request. In one example, the intra-day booking system 111 may receive a request from a user or from a third party (e.g., a travel agent) for booking a resource (e.g., a hotel room, a rental car, a conference room, etc.) for a few hours instead of a daily booking (e.g., normal check-in to check-out). In one embodiment, a partial booking period may be an increment of a regular booking period for a resource. For example, if a rental car is usually booked for one week, then a partial booking of the car rental may be for a few days instead of the entire week. In one embodiment, the user intra-day reservation request is a combined reservation request for the resource that includes a request for the daily booking period in addition to the intra-day booking period. For example, a user may already have an existing reservation (e.g., daily, weekly, intra-day, etc.) for a hotel room, and the user may also request for an intra-day reservation (e.g., extending use-time before or after the existing reservation) of the same hotel room resource.

At step 401, intra-day booking system 111 may modify a standard protocol for managing the resource to extend the protocol to support the intra-day reservation. In one embodiment, the standard protocol includes a Hotel Technology Next Generation (HTNG) protocol, an Extensible Markup Language (XML) protocol, or a combination thereof. For instance, an intra-day booking system 111 may interface with one or more entities of a resource booking/reservation system that may be using a HTNG protocol that provides interoperability among systems used in the hospitality industry. The intra-day booking system 111 may introduce one or more protocol parameters to modify (e.g., add) one or more features in the HTNG or XML protocols so that the existing standard may be utilized to support an intra-day reservation. For example, advanced features may be added to an existing standard protocol to present one or more options for selecting duration of time for an intra-day reservation.

At step 403, intra-day booking system 111 may present a resource owner-facing user interface for receiving an input from a resource owner for specifying a protocol, a rule, a parameter, or a combination thereof for indicating an availability of the resource, the intra-day booking period, or a combination thereof. In one embodiment, rules may provide directions or procedures for completing a reservation task in a booking system. For example, the rules for booking an executive level hotel room for a customer may require that the customer has a certain membership level at the hotel, or certain number of member points, etc. In one embodiment, a parameter may be a factor that can affect the results of a process. For example, a “location” parameter may limit the number of resources that may be available for intra-day reservations. In one embodiment, a user interface may be presented at a device of a provider, or an agent of the provider, associated with a resource that may be available for an intra-day reservation. The provider or its agent may select from one or more options presented via the user interface, wherein the intra-day booking system 111 may utilize the one or more selected options to specify, add or modify a protocol, a rule or a parameter for enabling an intra-day reservation. For instance, a hotel provider may select from one or more options that indicate only a certain types of rooms (e.g., suites) and only during certain days of a week/month (e.g., weekdays only) may be available for intra-day reservations.

At step 405, intra-day booking system 111 may present an end user-facing user interface for receiving an input for specifying a protocol, a rule, a parameter, or a combination thereof for indicating the user intra-day reservation request. In one embodiment, a user interface may be presented at a device of a user/customer, or an agent of the user, associated with a request for an intra-day reservation of a resource. The user, or the agent, may select from one or more options presented via the user interface, wherein the intra-day booking system 111 may utilize the one or more selected options to specify, add or modify a protocol, a rule or a parameter for enabling an intra-day reservation. For instance, a user may select from one or more options that indicate an interest in only a certain types of hotel properties (e.g., for business), wherein such properties may be associated with certain types of protocol, a rule, a parameter. The intra-day booking system 111 may utilize the one or more selected options to specify, add or modify a protocol, a rule or a parameter for enabling the intra-day reservation as per the user request.

At step 407, intra-day booking system 111 may initiate a daily reservation of the resource via a daily booking mechanism. In one example, the intra-day booking system 111, based on a request from a user, an agent, etc., may determine and present one or more hotel rooms/resources to the user or a user agent for a selection. Upon receiving a selection from the user/agent, the intra-day booking system 111 may initiate a daily/regular reservation of the hotel room. In one scenario, the intra-day booking system 111 may present a confirmation of the reservation to the user/agent.

At step 409, intra-day booking system 111 may extend the daily reservation to include the intra-day booking period via an intra-day booking mechanism, wherein the extended daily reservation (shoulder-time) is provided in response to the combined reservation request. In one scenario, an intra-day booking system 111 may receive a request from a user/agent for extending a daily reservation of a resource (e.g., hotel room). For example, a user may have a regular daily reservation for a hotel room, but may wish to check-in to the room earlier (e.g., at 10:00 AM) than a regular check-in time (e.g., 3:00 PM), wherein an intra-day booking/extension period may provide for the earlier check-in time (e.g., at 10:00 AM). In another example, the user may wish for a later check-out (e.g., at 8:00 PM) of a daily reserved room with a regular check-out time (e.g., 3:00 PM), wherein an intra-day booking/extension period may provide for the later check-out time (e.g., at 8:00 PM). In one embodiment, a resource provider rule or parameter may indicate that an intra-day booking is to be associated with a daily reservation of the same resource for the same user; e.g., an extension/shoulder-time for (e.g., adjacent in time, before/after) a regular daily booking for the same user.

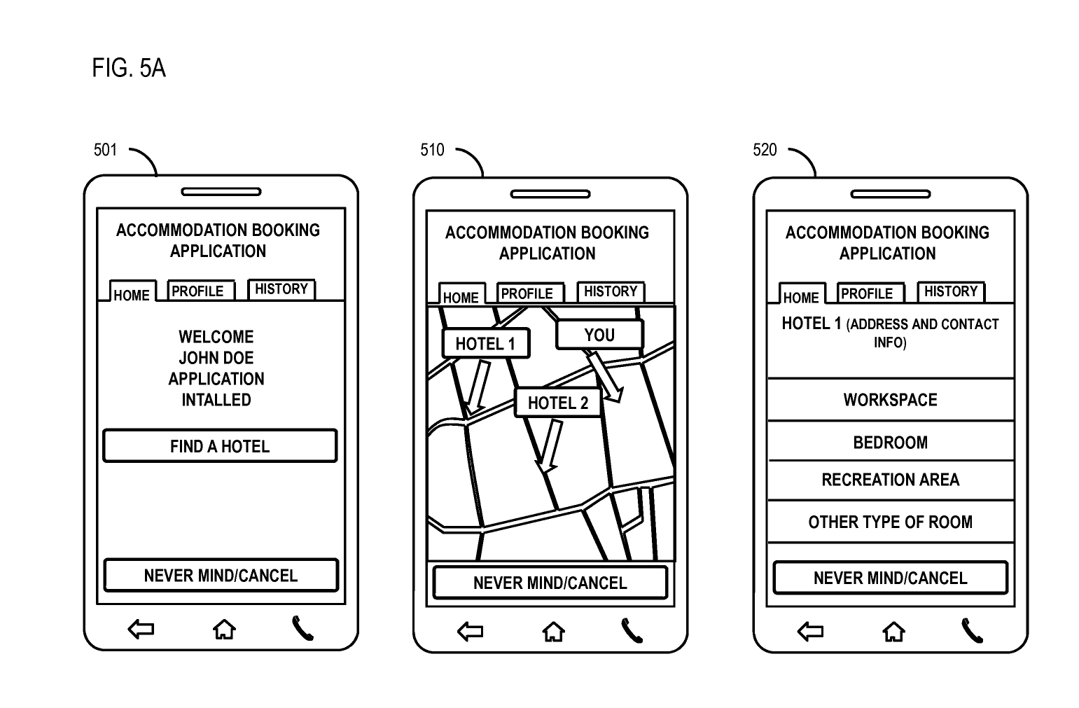

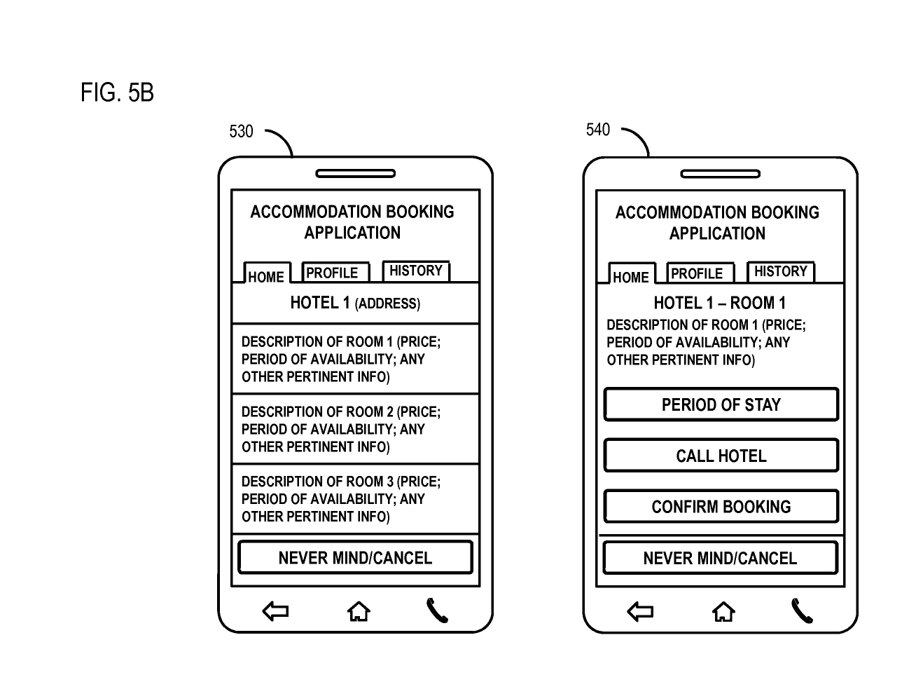

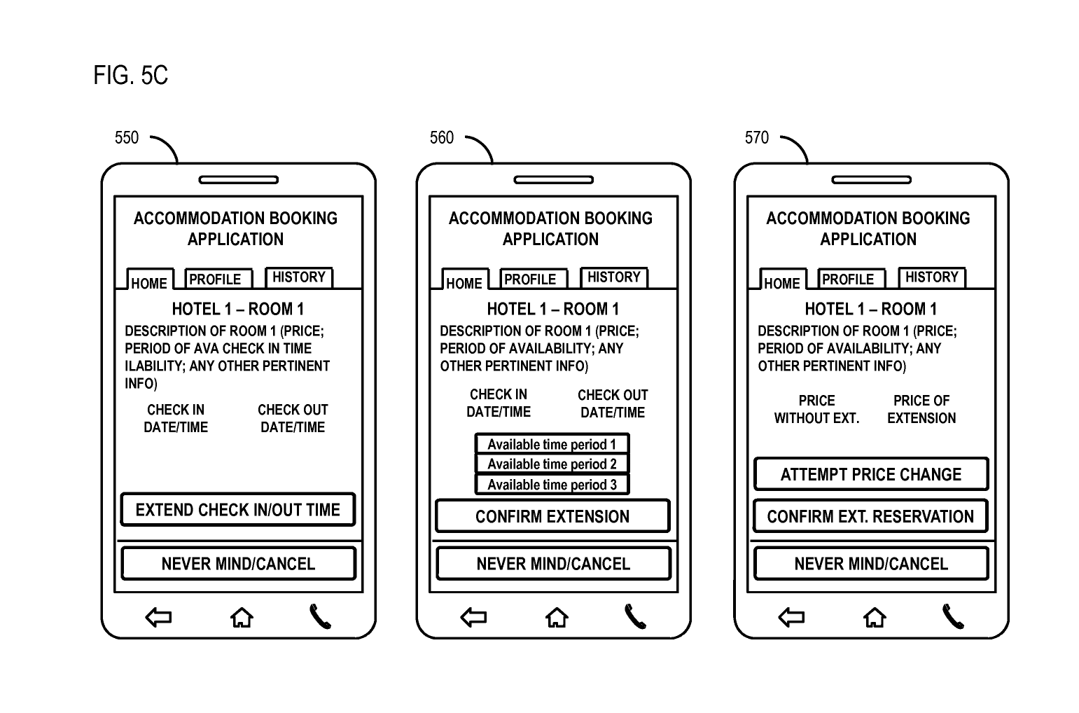

FIGS. 5A-5C illustrate diagrams of a user interface for making intra-day reservations, according to various embodiments.

FIG. 5A illustrates a UI 501 at a user device (e.g., a mobile phone, tablet, etc.) where in one example use case, a customer arrives at an airport at 6:00 AM and has a flight at 2:00 PM. The customer wishes to reserve a room from 7:00 AM to 1:00 PM. The customer may use his mobile device to search for a nearby hotel based, at least in part, on location information, current availability, preference information, services availability information, or a combination thereof (in another scenario where the customer wishes to book a room in advance, the customer may insert the location where he will be at a certain time). In UI 510, the customer may be presented with a number of location options (e.g., on a map), and in UI 520, a list of resource types, booking options, names of hotels, or the like information may be presented to a user of the user device. In one example, the availability information may indicate one or more resources that may be available right away for a given time period or a time period identified by the user.

In FIG. 5B, the customer may utilize UI 530 to check the prices, the availability of rooms, or other information associated with the room, and then the customer may utilize UI 540 to make a reservation without his credit card, or may be guaranteed a reservation by adding his credit card information. Subsequently, the room is reserved and he can use the room from 7:00 AM to 1:00 PM. This allows him to work comfortably during at least part of the eight hours window between flights. At the same time, the hotel was able to monetize the room that otherwise would have been left empty, and the hotel did not have to assign anyone to service the customer regarding the reservation. The customer was able to effortlessly provide his information to the PMS (e.g., a hotel booker), and was automatically notified that a room was available during his requested time frame. Further, the hotel can also be alerted that the same room can be made, or will be made available to another eventual guest after the 1:00 PM. Subsequently, if this other user reserved the room until 5:00 PM, the same space may be later rented to a third customer after 5:00 PM.

In UI 550 of FIG. 5C, the customer may request to extend his stay at the hotel until the next day by specifying a date and check-in/check-out times, for example, if his 1:00 PM flight is cancelled. In UI 560, the user may be presented with a list of options (e.g., date, time period, price, room type, etc.) for the requested extension, wherein the extension may be completed through a UI 570 on the same device (e.g., mobile device) or another device (e.g., a tablet) by the user via a touch based interaction (e.g., by a one click touch).

By using the platform herein provided, the hotel can offer, and the customers can take advantage of various discount rates (e.g., day discount rate, or an 11:00 AM through 4:00 PM reservation discount rate), while allowing the hotel to efficiently manage the room occupancy through intra-day bookings throughout the day.

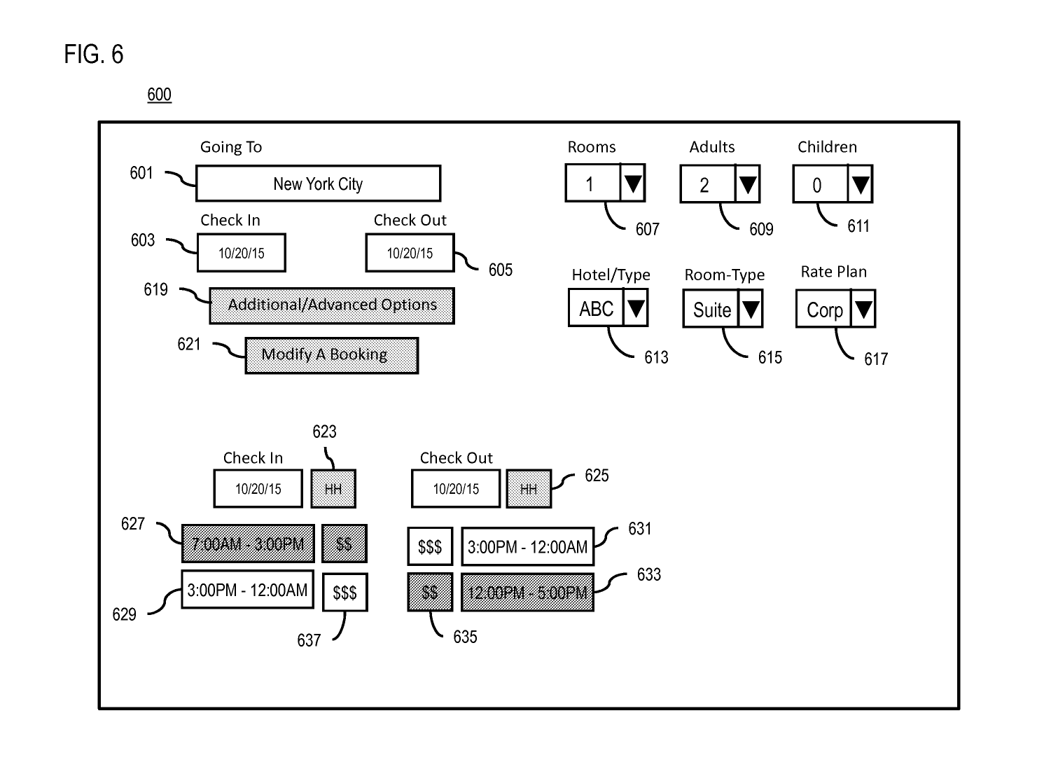

FIG. 6 illustrates an example user interface 600 including options for an intra-day reservation system, according to one embodiment, which may allow providers to manage possible intra-day reservations and/or shoulder extensions. The interface may include options to indicate promo code, room type, number of rooms, rate plan, occupancy, intra-day time period during before the check in and after the checkout times, dates around the overnight stay, selections of shoulder times for check in and/or checkout, etc. It is also contemplated that this interface can display information, such as shoulder time booking and/or request confirmation, which may be displayed as a separate reservation from the over-night reservation, as a comment to the original over-night reservation. It is contemplated that in cases where the shoulder reservation is confirmed through other means, such as by sending a notification by email, this interface may indicate whether the confirmation or comments have been sent to the providers and/or users. In one scenario, various UI elements may allow input for a destination at 601, a check-in date at 603, a check-out date at 605, number of rooms at 607, number of occupants at 609 and 611, a hotel or hotel type at 613 (e.g., hotel ABC, a business-type hotel, a family friendly hotel, etc.), a room-type at 615 (e.g., suite, single, double, etc.), a rate plan at 617 (e.g., corporate, club membership, etc.) In one embodiment, a user may select a UI element 619 for additional/advanced options or an element 621 for modifying a current booking. In one example, the additional/advanced options may present an option 623 to indicate a check-in time and an option 625 to indicate a check-out time, wherein depending on a requested resource and its provider, one or more options may be presented to a user/agent. For instance, check-in times 627 and 629, and check-out times 631 and 633 present different blocks of time, which may qualify as an intra-day reservation or extension request. In one embodiment, an option for an intra-day reservation or shoulder/extension request may be marked (e.g., highlighted, noted, etc.) in a UI presentation. For example, the check-in time 627 is highlighted to indicate as an intra-day reservation or shoulder/extension, where the check-in time 629 is not highlighted and may be a regular daily reservation. In one example, a price indicator 635 may be presented for the intra-day reservation or shoulder/extension option and a price indicator 637 for the daily reservation option.

In one embodiment, a user can search for accommodation using any device configured to determine corresponding spatial positioning information through conventional satellite positioning system (SPS) technology, such as GPS technology; however, any suitable navigational or location determination technology may be utilized, such as advanced forward link trilateration (A-FLT), assisted-GPS (A-GPS), enhanced cellular identification (CELL-ID), wireless area network (WLAN) positioning, Bluetooth low energy devices (e.g., iBeacon), etc.

The platform herein provided, includes at least a user interface, a protocol, and an algorithm for enabling the last-minute or intra-day booking of space during the day and for less than a day. As previously noted, the system includes an application(s) or program(s) that may provide or use a business logic layer and database which stores information about the hotel, such as its rates and inventory. Additionally, the application(s) or program(s) may interface directly with the channel managers, the hotel administration, and the consumer requests from online and/or mobile applications.

In one embodiment, the platform may be able to directly offer rooms or other services to customers, receive user input, send confirmation to the hotel and the client, calculate and store commission, save user profile and preferences, search and list lodging space, manage inventory and promotions, provide business intelligence for hotel managers, receive and send an input to other systems (such as PMS), among others.

In one embodiment, the platform has tools that allow one or more hotels to set protocols and rules on how to manage their supply of rooms or other resources. For example, a hotel may be able to choose a one hour gap between check out of a guest and check in of a subsequent guest so the hotel has some time to prepare the room for the subsequent guest. On the other hand, other hotels may choose a half hour gap. If the hotel management wishes to change a one hour gap to a half hour gap, it may do so by simply inserting it in the system, using the system's interface. In one embodiment, the platform may be able to calculate the time a guest would take to get to the hotel by integrating the location information of the user/guest and the time it will take for the guest to arrive at the hotel, with the gap information by a hotel. For example, the system recognizes that a guest checked out from a hotel room at 8:00 AM and it would take half hour for the hotel to prepare the room. In one scenario, another guest is trying to book the same room at the hotel at 8:05 AM. In this case, the system books the room in the hotel if it recognizes that the new guest is able to check in approximately at 8:30 AM. This approximation is based on the fact that the new guest may take about 30 minutes to reach the hotel from the airport. Accordingly, even though the hotel room is not prepared and available for the new guest at the time of booking, the system will be able to book the hotel room because it recognizes that the room will be ready for the new guest at the time of his arrival at the hotel. In some scenarios, the intra-day resources may be available from various providers without a predetermined type, quantity, price, or the like conditions. For example, the resources may be available on a free-sell basis by various providers.

In one embodiment, the platform is also capable of distributing new booking requests by prioritizing vacant spaces, or based on user's history (e.g., user does not usually extend his/her stay) or on any other criteria, such as time, location, season, special events, and others. This allows the platform to provide business intelligence to hotels and to suggest other hotels in case a certain hotel is fully booked. For example, the hotel management may have a special discount for a certain type of room, such as a workspace. In this case, the platform may be able to offer the workspace before offering any other space. Additionally, it may be able to offer a workspace only to a businessman, or to people that usually book this type of space.

In another embodiment, the platform may be made available as white label or a co-branded. For example, a customer may visit a hotel's website and book a room using the platform herein provided thinking that the reservation was made directly with the hotel. In other words, the platform can be rebranded with the provider's brand. It is also contemplated that e.g., a co-branded widget is placed in the provider's website for providing intra-day reservation.

In one embodiment, the platform may also access open source databases in order to perform any of its functions, such as accessing flight information in order to predict and/or prioritize stay extension by a customer. It is also contemplated that the platform may be able to connect to the active segment of GDS for amending reservations using traveler's record locator (Passenger Number Record—PNR), or any other unique identifier.

In one embodiment, it is also contemplated that the system may be able to offer different types of services such as a premium membership where a certain hotel is highlighted at a user/guest's interface. From the user/guest's perspective it is also contemplated that the hotel may offer a premium membership for users/guests, where some type of special treatment is provided, such as a free dinner while the user is enjoying his stay.

In one embodiment, the infrastructure includes a PMS for managing inventories, rates, occupancy, etc., a CMS for connecting the inventories, rates, occupancy, etc. with agents, which includes travel agencies, and online travel agents. Other third party systems may be part of this infrastructure that may allow hotels to offer items that are offered only one time (one-off items) including sale inventory.

In one embodiment, it is contemplated that the platform may be configured to generate/collect signals to/from user devices utilizing any suitable bearer, including short messaging service (SMS) messages, enhanced messaging service (EMS) messages, multimedia messaging service (MMS) messages, electronic mail, files, or any other suitable bearer, as well as any suitable combination thereof. In particular implementations, these bearer mediums may include signals in various forms, including attention (AT) commands, menu traversal paths, function codes, voice data, dual-tone multi-frequency (DTMF) signals, scripts, strings, parameters, object variables, and the like. It is noted that these control signals can be used in lieu of “software code,” and therefore, may be directly integrated into the control logic of e.g., a mobile device, thereby requiring less processing and hence, less power.

In one embodiment, the platform is capable of generating revenue projection reports and to make other revenue management tools available. For example, the platform may have the ability to look at current dates and/or future dates and predict availability, booking pace, etc.

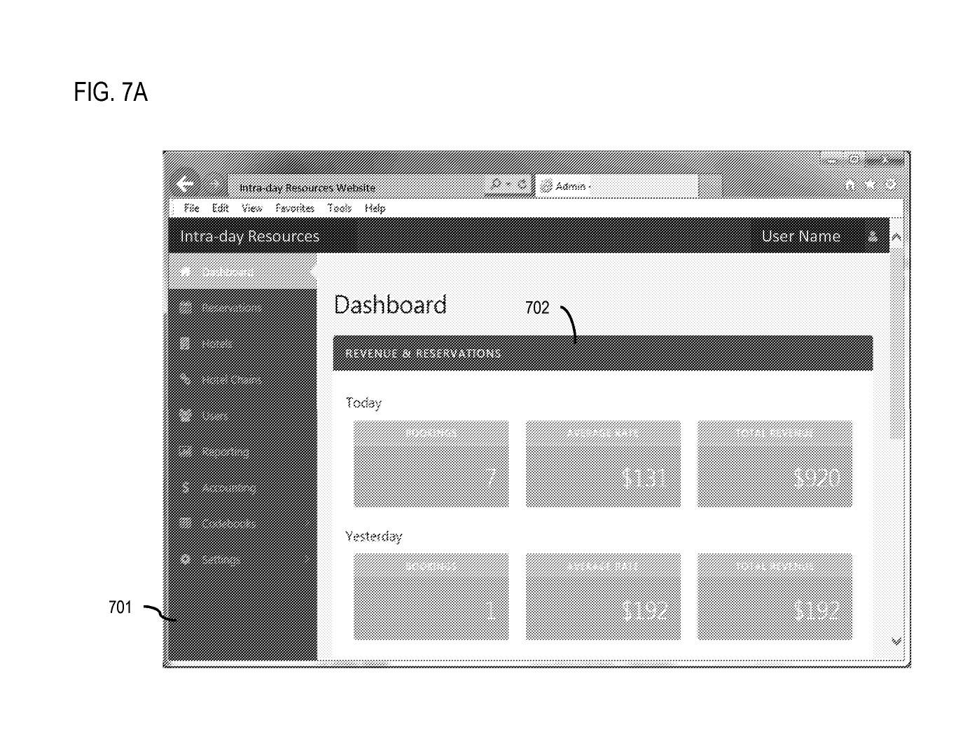

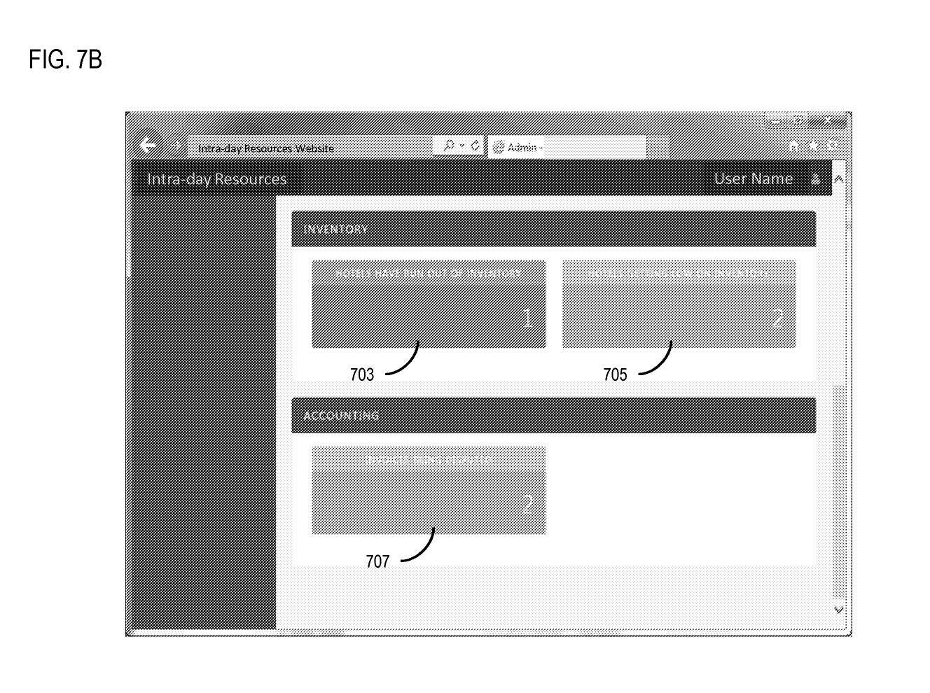

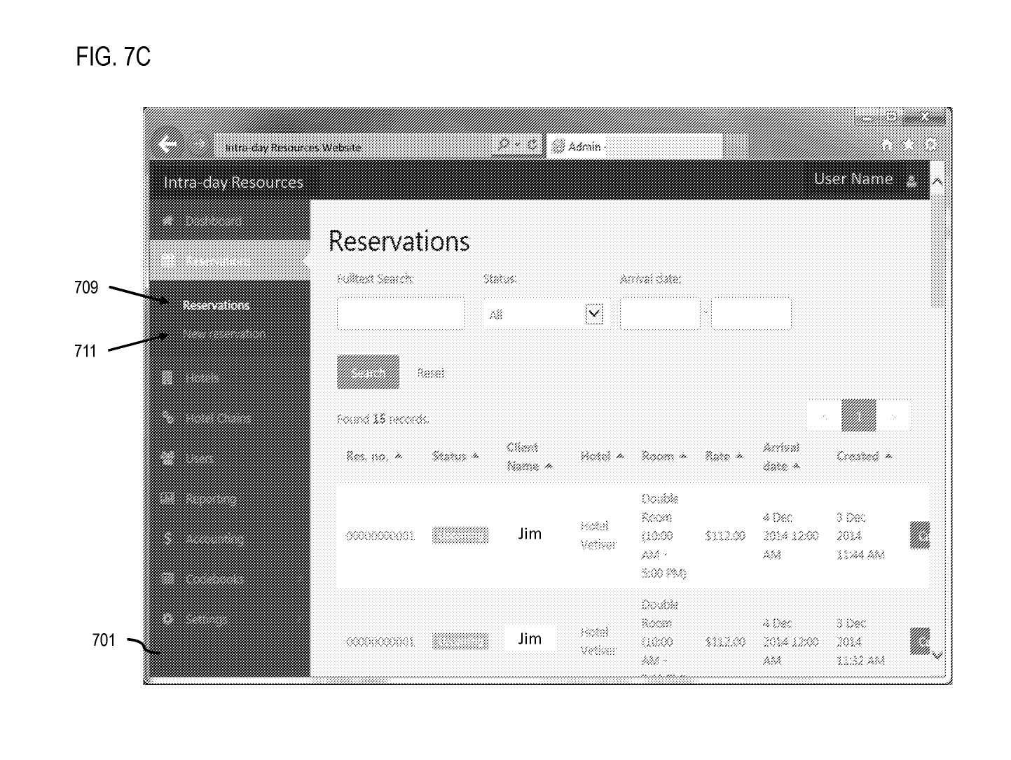

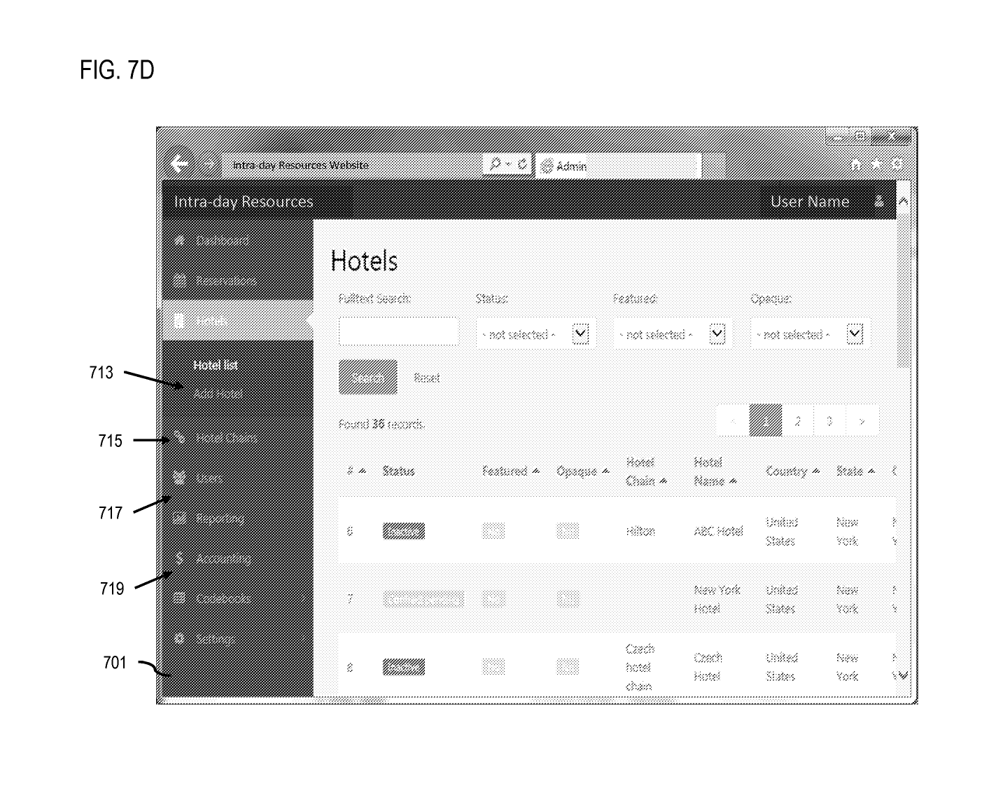

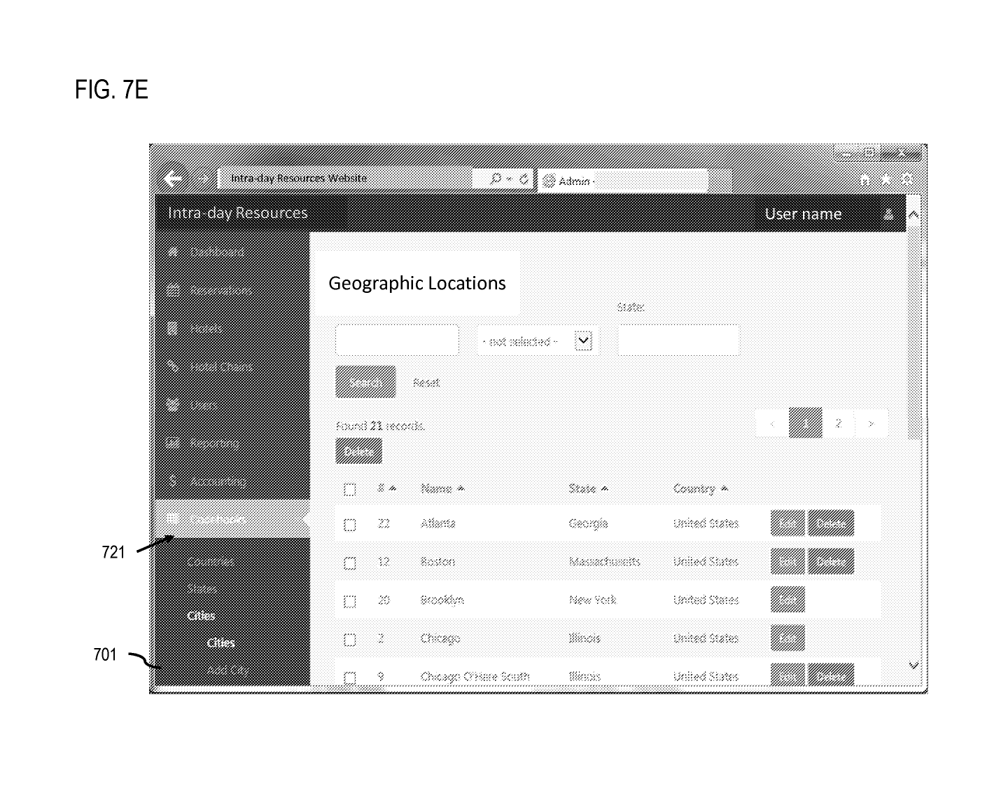

FIGS. 7A-7B illustrate diagrams of a dashboard user interface for monitoring intra-day reservation system activities, according to one embodiment. This interface may be viewed by a system manager or by a system manager with a view to the Hotel Manager. The user interface provides a summary or snapshots, in an easy-to-read form of intra-day activities, including, but not limited to number of bookings, average rate, total revenue by any day or period (e.g., week-to-date, month-to-date, and year-to-date), inventory, and accounting information. In one embodiment, it is contemplated that this dashboard is the main user interface of the system. In FIG. 7A, a list 701 including various menu items for facilitating navigation through the website may be provided. In this example, the navigation items include links for accessing the dashboard, reservations, hotels, hotel chains, users, reporting, accounting, codebooks, and settings. In one embodiment, this list of navigation items may be provided in every user interface to provide a consistent user interface that relates the user current position within the pages of the system as well as to facilitate navigation between the pages. In one embodiment, an RMS 227 may provide data on revenue and reservations 702, which may include number of bookings, average rates, total revenue, or the like information for a given date or time period.

FIG. 7B is another view of the dashboard of FIG. 7A for monitoring the intra-day reservation system activities. More specifically, FIG. 7B depicts a user interface in which the information presented is limited according to the user or role of the user accessing the system, e.g., multi-level permissions. In this example, the user interface of FIG. 7B presents information that is relevant to a hotel manager. As mentioned above, a hotel manager may have limited access to some of the information in this interface, or in any other interface. For example, the hotel manager may have access only to inventory and accounting information, while other information in the system may be available only to the system manager. A hotel manager's permissions may be for multiple hotel properties that may be indirectly affiliated (e.g., different hotel chains) as they may be owned or managed by a same entity (e.g., a person, a corporation, etc.)

In one embodiment, the system may determine which hotels have run low or out of inventory, may generate an aggregated report with this information and other relevant information, and may send or display this information to the system managers, to hotel managers, or to any other user. This information may be rendered through the portal, such as in FIGS. 7A-7B, by email, or any other means. Furthermore, the system may be able to simulate scenarios and provide information regarding expected and past revenues, bookings and average rates. This information may also be available through the dashboard or may be sent to interested parties. It is contemplated that the portal or the report may indicate invoices disputed by the system manager and/or hotel managers. A hyperlink may take the system manager, hotel managers, or any other user/provider to another related page within the application.

FIG. 7C is a diagram of a user interface for managing reservations in the intra-day reservation system, according to one embodiment. Users, such as hotel managers, can view, filter, and manage reservations reports by multiple variables, such as reservation numbers, status of the reservations (e.g., whether the reservation was cancelled, upcoming, past, or now shown reservations). Other information such as client names, hotel names, room types, time bands, rate, arrival date and the date booked can also be viewed by users/providers. For example, if a guest cancels the reservation this information can be view in this interface. Reservations can also be cancelled, restored and made active again through this interface. It is contemplated that each reservation can be viewed in more detail when the user/provider or system manager clicks on the reservation number. As demonstrated in FIG. 7C, it is also contemplated that a reservation can be searched by arrival/checkout date and/or by arrival time.

In some embodiments, a guest/user may make a reservation through a user interface option 709 at an intra-day resources reservation system's website, a hotel's website, the managing system's website, by phone, or by any other means. It is contemplated that a hotel website may host a widget for booking the directly with the system. Accordingly, the guest may complete the entire reservation and believe he/she have booked directly through the hotels website via a white labeled page.

In one embodiment, a menu option 711 may enable the hotel manager or other users/providers to manually add new reservation. For example, if a guest calls the hotel, the hotel manager can access this interface and manually add the reservation within the application back end and confirm it to the guest and/or to the hotel that the reservation was made. Access to this interface may be permitted based on role (e.g., only hotel managers) or any other parameter. For example, the porter of a hotel may not be able to access this interface or any interface of the system. It is contemplated that the reservation may be automatically added once a user/guest confirms a reservation in the hotel's website, through an agent, or through the system portal. Accordingly, this interface may not need to be used in order for a user/guest to be able to make a reservation, where the reservation may be made by the hotel via the hotel manager admin interface.

FIG. 7D illustrates a list of participating hotels in the intra-day reservation managing system, according to one embodiment. This interface enables a user to view a master list of each hotel. For example, a hotel chain manager may be able to see all the hotels that are part of the chain or that are somehow associated with the chain. The hotels may be filtered by a hotel specified ID, by a status (e.g., active, contract pending, inactive and contract declined), or featured hotels. It is contemplated that this interface enables the user to view whether a hotel is featured in the front page of the system's website.

Hotels can also be classified as ‘opaque’, which means they are available but the user/guest may only know which hotel he/she booked at the final point of the registration, when the user/guest is about to confirm the reservation through a user/guest interface. This interface also enables users/providers to filter by hotel chain, hotel name, or country, state or city where the hotel is located. Users can also view the profiles of the hotels and access their inventory and types of rate (e.g., hourly, by minute, etc.) from this screen.

In some embodiment, a user interface option for adding new hotels in the intra-day reservation managing system. This interface enables the user, such as a hotel manager, to onboard a hotel. It is contemplated that this set up process and/or user interface may include basic information, taxes and fees, the location, amenities, hotel images, inventory, availability and terms and conditions. The information can be edited, removed or added, or the like actions may be executed via various menu or sub-menu options. The user/provider can communicate directly with the system management while doing the set up, and the system can automatically send the terms and conditions to the hotel in real time so the hotel can get immediate access to the hotel manager backend portal and to start using the system.

A user interface option 715 may be utilized for managing participating hotels chains in the intra-day reservation system. This interface enables the user/provider or a system manager to set up a global chain, to attach any hotel to an existing chain (e.g., affinity with a hotel, a hotel of a chain), or to remove a hotel from being associated with an existing chain. A hotel can be set up without a hotel chain and be attached to one at any time.

Also, a system manager may add new hotel chains to be included in the system, simply by inserting the chain information. It is contemplated that this and other user interface can be accessed from the hotel setup page or portal, or from the system website.

A menu option 717 may be utilized for managing users/provider of the intra-day reservation system. The users may be managers of hotels, system managers or managers of other managing systems. A hotel manager may have access to some features of the system and some user interfaces in varying scope. For example, the manager may only have access to the information related to his/her hotel, i.e. information such as names of other managers, information related to guests of another hotel, revenue of another hotel, or any proprietary information may be omitted.

In one embodiment, three levels of users may be categorized: system manager, hotel managers, and hotel chain managers. A user/provider can be created during the hotel set up process or added at any other time. It is contemplated that different hotels may have different levels of access/clearance. This includes clearance for adding other user, for managing hotel chains, for allowing other affiliated hotels to be listed as part of a certain chain, etc. For example, a hotel chain management may not wish to allow the hotel manager to add hotel managers to the system, while other hotel chain managements may allow a manager to add another manager to the system. It is also contemplated that all users' rights and permissions can be set up to give access to all pertinent areas of the application. Additionally, a user account can be deactivated, deleted or made active.

In one embodiment, an email address may be connector to relate any user to any specific hotel, hotel chains, roles within a hotel, level of access to information etc.

In one embodiment, a new user account can be created for any user, such as hotel manager or a hotel chain manager. Permission can be granted to areas such as reservations, hotels, hotel chains, user, report, accounting, codebooks and settings as applicable based on that user role, or any other parameter.

In various embodiments, the system intra-day reservation system can be programmed according to each user or client needs. For example, through a menu option 719 “Accounting”, the system can be programmed so a final invoice can be generated automatically within 5 days of the end of a month or billing period, or as defined by the user. A hotel during this period would have had a chance to dispute the invoices and the managers of the system are able to rectify and resubmit the invoice. This user interface may allow the user to see from their back end portal the invoices and the reservations due for payment. It is contemplated that an invoice can be generated in PDF or any other format, can be edited by specific reservation or by invoice. Additionally, an invoice status (e.g., overdue, disputed, paid etc.) can be generated by invoice number, hotel, user, client, or any other parameter.

FIG. 7E illustrates information on intra-day resources by geographic locations such as cities, states, countries, or the like regions, according to one embodiment. The information, listed in a menu option 721 as “Codebooks”, may be under the system manager's control, and/or be under limited access by the user. A user/provider can edit, delete, search, or add countries, states within a country, cities within states and/or countries. This section may also be linked into the hotel and/or hotel chain set up and can be made accessible on the website front end.

In various embodiments, amenities at a hotel can be edited on, deleted from, searched, or added to a list associated with a hotel or hotel chain. Also, room types can be edited on, deleted from, searched, or added to the list. When amenities, room type or any other feature of the hotel is added to the list, this information will be available to guest, who may schedule a reservation based on these information. When added, the information is also made available to hotel and other system users/providers for setting up their inventory or rates, or other features. It is also contemplated that other options may be added to the system for allowing the system managers, hotel managers and other clients to add these features of the hotel to the system.

In another embodiment, a client source can be edited, removed, searched, and added, wherein a user source may include for example, a survey (e.g., how customer, guests, or other clients heard about the hotel, the website, or the managing system). Client source may also include access to newspapers, any special treat or membership, etc.

In another embodiment, a list of options including terms and conditions associated with a service provided by the intra-day reservation system may be presented via the intra-day resources user interface. The users/providers can choose the terms and conditions of the service between the user and the managers of the system. For example, the terms can be month to month, 12 months and 24 months, etc. These terms and conditions may be sent to the hotel manager during the hotel set up process and can be auto generated from the information given during the set up period.

In one embodiment, the intra-day resources user interface may include an email queue for communications related to the intra-day reservation system. In one scenario, users may intercept a copy of the emails or other communications that the system automatically generated or that are send by a representative of the managing system or the hotel manager. This allows the users and system managers to refer back to communication between parties, to identify any issue that may have occurred, or to check for confirmation that, e.g., an email was sent to the user.

FIG. 8 is a diagram of a computer system that can be used to implement various exemplary embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 05. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g., for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted, multiple communication interfaces can also be employed.

The network link 819 typically provides data communication through one or more networks to other data devices. For example, the network link 819 may provide a connection through local network 821 to a host computer 823, which has connectivity to a network 825 (e.g., a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

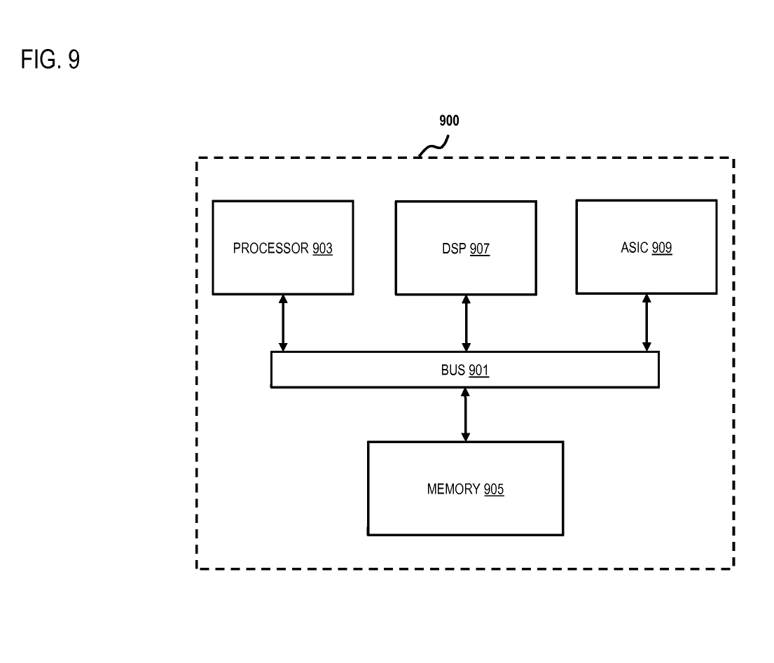

FIG. 9 illustrates a chip set or chip 900 upon which an embodiment of the invention may be implemented. Chip set 900 is programmed to deliver messages to a user based on their activity status as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling the transmission of files independent of a file transfer application or the throughput capabilities of the sending or receiving devices.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to deliver messages to a user based on their activity status. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
specifying an intra-day booking period for a resource, wherein the intra-day booking period is a period less than a daily booking period for the resource;
interfacing with a channel manager platform to provide for an intra-day reservation of the resource based on the intra-day booking period, wherein the channel manager platform is configured to manage the resource; and
initiating the intra-day reservation of the resource based on a user intra-day reservation request.

2. A method of claim 1, wherein the channel manager platform further interfaces with a resource property management system to manage the resource.

3. A method according to claim 1, further comprising:
modifying a standard protocol for managing the resource to extend the protocol to support the intra-day reservation.

4. A method of claim 3, wherein the standard protocol includes a Hotel Technology Next Generation (HTNG) protocol, an Extensible Markup Language (XML) protocol, electronic data interchange for administration, commerce and transport (EDIFACT) protocol, or a combination thereof.

5. A method according to claim 1, further comprising:
presenting a resource owner-facing user interface for receiving an input from a resource owner for specifying a protocol, a rule, a parameter, or a combination thereof for indicating an availability of the resource, the intra-day booking period, or a combination thereof.

6. A method according to claim 1, further comprising:
presenting an end user-facing user interface for receiving an input for specifying a protocol, a rule, a parameter, or a combination thereof for indicating the user intra-day reservation request.

7. A method according to claim 1, wherein the user intra-day reservation request is a combined reservation request for the resource that includes a request for the daily booking period in addition to the intra-day booking period.

8. A method of claim 7, further comprising:
initiating a daily reservation of the resource via a daily booking mechanism; and
extending the daily reservation to include the intra-day booking period via an intra-day booking mechanism,
wherein the extended daily reservation is provided in response to the combined reservation request.

9. An apparatus comprising:
at least one processor; and
at least one memory including computer program code for one or more programs,
the at least one memory and the computer program code configured to, with the at least one processor, cause the apparatus to perform at least the following,
specify an intra-day booking period for a resource, wherein the intra-day booking period is a period less than a daily booking period for the resource;
interface with a channel manager platform to provide for an intra-day reservation of the resource based on the intra-day booking period, wherein the channel manager platform is configured to manage the resource; and
initiate the intra-day reservation of the resource based on a user intra-day reservation request.

10. An apparatus of claim 9, wherein the channel manager platform further interfaces with a resource property management system to manage the resource.

11. An apparatus according to claim 9, wherein the apparatus is further caused to:
modify a standard protocol for managing the resource to extend the protocol to support the intra-day reservation.

12. An apparatus of claim 11, wherein the standard protocol includes a Hotel Technology Next Generation (HTNG) protocol, an Extensible Markup Language (XML) protocol, electronic data interchange for administration, commerce and transport (EDIFACT) protocol, or a combination thereof.

13. An apparatus according claim 9, wherein the apparatus is further caused to:
present a resource owner-facing user interface for receiving an input from a resource owner for specifying a protocol, a rule, a parameter, or a combination thereof for indicating an availability of the resource, the intra-day booking period, or a combination thereof.

14. An apparatus according to claim 9, wherein the apparatus is further caused to:
present an end user-facing user interface for receiving an input for specifying a protocol, a rule, a parameter, or a combination thereof for indicating the user intra-day reservation request.

15. An apparatus according to claim 9, wherein the user intra-day reservation request is a combined reservation request for the resource that includes a request for the daily booking period in addition to the intra-day booking period.

16. An apparatus of claim 15, wherein the apparatus is further caused to:
initiate a daily reservation of the resource via a daily booking mechanism; and
extend the daily reservation to include the intra-day booking period via an intra-day booking mechanism,
wherein the extended daily reservation is provided in response to the combined reservation request.

17. A system comprising:
an intra-day reservation platform; and
a channel manager platform,
wherein the intra-day reservation platform is configured to:
specify an intra-day booking period for a resource, wherein the intra-day booking period is a period less than a daily booking period for the resource;
interface with the channel manager platform to provide for an intra-day reservation of the resource based on the intra-day booking period, wherein the channel manager platform is configured to manage the resource; and
initiate the intra-day reservation of the resource based on a user intra-day reservation request.

18. A system of claim 17, further comprising a property management system,
wherein the channel manager platform further interfaces with the resource property management system to manage the resource.

19. A system according to claim 17, wherein the intra-day reservation platform is further configured to perform at least one of:
present a resource owner-facing user interface for receiving a first input from a resource owner for specifying a first protocol, a first rule, a first parameter, or a combination thereof for indicating an availability of the resource, the intra-day booking period, or a combination thereof; and
present an end user-facing user interface for receiving a second input for specifying a second protocol, a second rule, a second parameter, or a combination thereof for indicating the user intra-day reservation request.

20. A system according to claim 17, wherein the user intra-day reservation request is a combined reservation request for the resource that includes a request for the daily booking period in addition to the intra-day booking period, and wherein the intra-day reservation platform is further configured to:
initiate a daily reservation of the resource via a daily booking mechanism; and
extend the daily reservation to include the intra-day booking period via an intra-day booking mechanism,
wherein the extended daily reservation is provided in response to the combined reservation request.

21.-28. (canceled)
